(19) United States
(12) Patent Application Publication
(10) Pub. No.: US 2012/0057010 A1
(43) Pub. Date: Mar. 8, 2012

(54) ENDOSCOPE APPARATUS

(75) Inventor: Hideyoshi YAMAUCHI, Tokyo (JP)

(73) Assignee: Olympus Corporation, Tokyo (JP)

(21) Appl. No.: 12/877,165

(22) Filed: Sep. 8, 2010

(51) Int. Cl. H04N 7/18

(52) U.S. Cl. 348/76; 348/E07.085

(57) ABSTRACT

An endoscope apparatus includes an insertion tube including a flexible tube portion, a bending system, and an image pickup device, the bending system including a plurality of actuators which are provided in the flexible tube portion. The endoscope apparatus further includes a drum around which the insertion tube is wound. The plurality of actuators in the endoscope apparatus are positioned such that when the insertion tube is pulled out from the drum by a first length, a single symmetrical direction movement is enabled, and when the insertion tube is pulled out from the drum by a second length, a double symmetrical direction movement is enabled.

### BACKGROUND OF THE INVENTION

1. Field of the Invention

The present invention relates to an endoscope apparatus including an insertion section configured to be housed by being wound around a drum.

2. Description of the Related Art

In recent years, endoscope apparatuses having an elongated endoscope insertion section which can be housed by being wound around a drum have been used in industrial fields. If such endoscope apparatuses are used, it is possible to observe or inspect flaws, corrosion, or the like inside boilers in various factories, gas turbine engines, bodies of automobile engines, or pipes in various plants by inserting the insertion section pulled out from the drum.

Some endoscope apparatuses are provided with a bending portion at a distal end part of an insertion section in order to improve an insertion performance into a part to be inspected and an observation performance. The bending portion is bent by pulling wires using a motor for bending driving provided in the main body of the endoscope apparatuses, for example. In the endoscope apparatuses having such a configuration, when an operator operates a remote controller, for example, the motor is driven as needed to cause the bending portion to be bent.

However, in a case of the endoscope apparatuses having the bending portion at the insertion section, when the amount of insertion section to be reeled onto the drum is large, it becomes difficult to pull the wire using the motor and there is a possibility that the bending portion cannot be bent at all.

In order to avoid such a problem, an operator has conventionally pulled out the entire insertion section from the drum in advance before performing inspection. However, an extra portion of the insertion section pulled out from the drum is placed around the operator's feet. Therefore, during the inspection, the extra portion of the insertion section may possibly interfere with the inspection.

Japanese Patent Application Laid-Open Publication No. 2001-275928 discloses a user-friendly endoscope apparatus, wherein operation and non-operation of an electric apparatus can be controlled in response to pulling-out and rewinding of the insertion section. According to such an endoscope apparatus, permission and inhibition of the bending action can be switched depending on the state of insertion section wound around the drum. Therefore, it is possible to surely prevent an excessive load on the wire or the motor and to perform bending operation only in the bending action permission state.

Japanese Examined Patent Application Publication No. 6-67378 discloses an endoscope including an insertion section provided with fluid actuators. The fluid actuators are configured to pull and relax wires by expansion and contraction of hydrodynamic muscles by supplying and discharging fluid to and from the hydrodynamic muscles.

### SUMMARY OF THE INVENTION

An endoscope apparatus of the present invention includes an insertion tube including a flexible tube portion, a bending system, and an image pickup device, the bending system including a plurality of actuators which are provided in the flexible tube portion. In addition, the endoscope apparatus further includes a drum around which the insertion tube, wherein the plurality of actuators are positioned such that when the insertion tube is pulled out from the drum by a first length, a single symmetrical direction movement is enabled, and when the insertion tube is pulled out from the drum by a second length, a double symmetrical direction movement is enabled. The bending system further comprises a plurality of wires each having a first end connected to a bending portion of the insertion tube, and a second end respectively connected to the plurality of actuators, wherein the plurality of actuators comprise a first actuator group which bends the bending portion in an upward/downward direction, and a second actuator group which bends the bending portion in a leftward/rightward direction. And according to the present invention, the first actuator group and the second actuator group are disposed with a predetermined distance thereinbetween in a longitudinal direction of the insertion tube, and the predetermined distance is set in advance in accordance with a shape of a pipe into which the insertion tube is to be inserted.

### DETAILED DESCRIPTION OF THE DRAWINGS

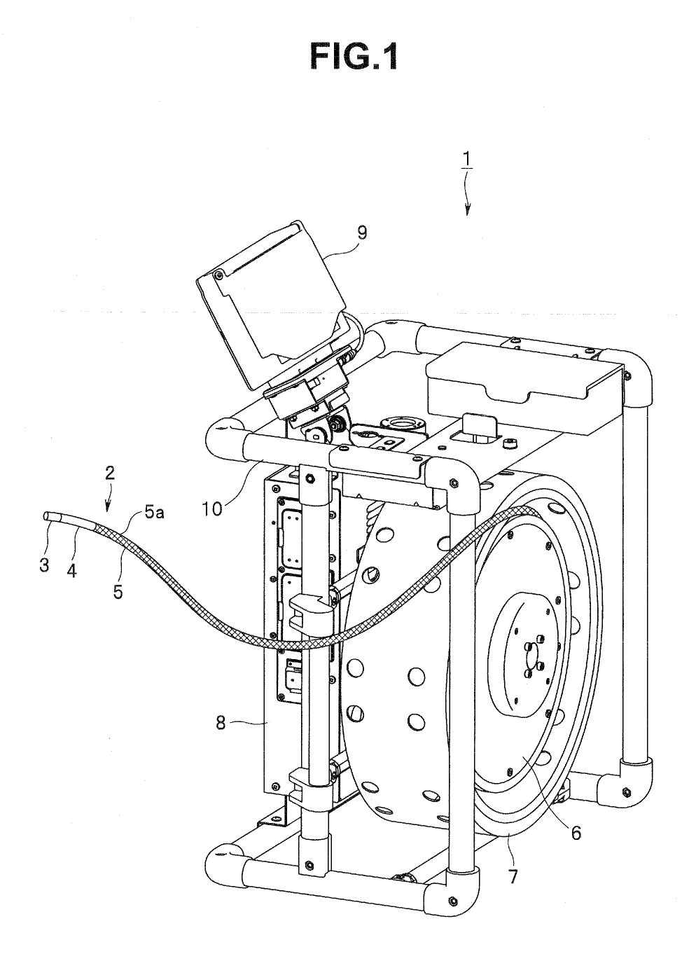

FIG. 1 is a perspective view illustrating a configuration of an endoscope apparatus.

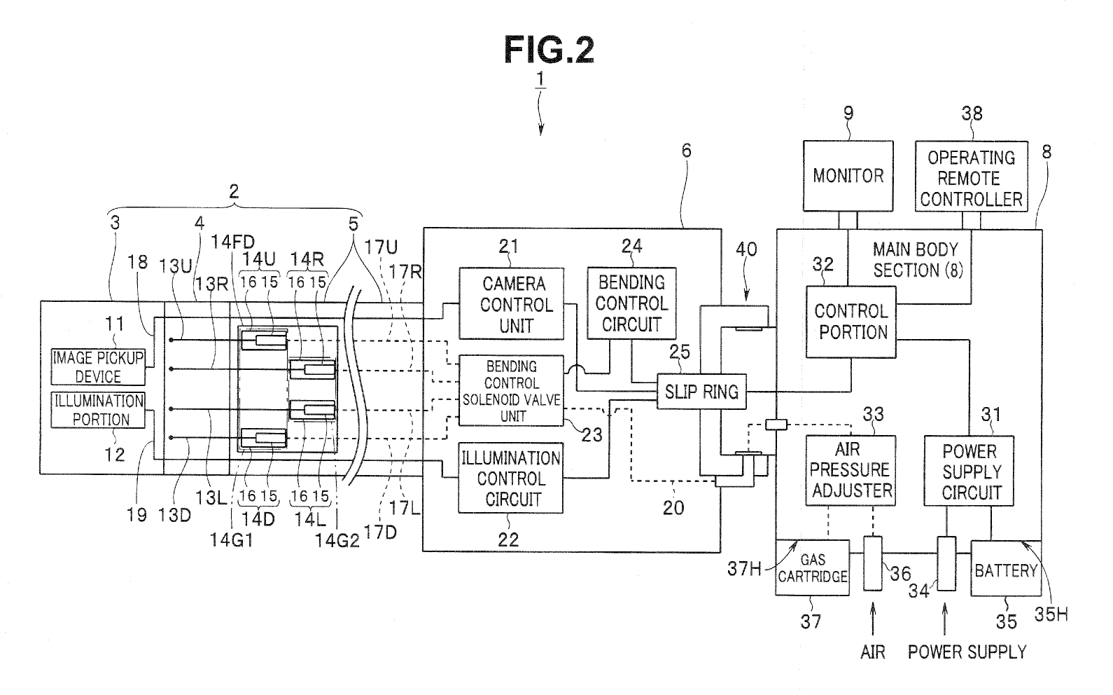

FIG. 2 is a block diagram illustrating the configuration of the endoscope apparatus.

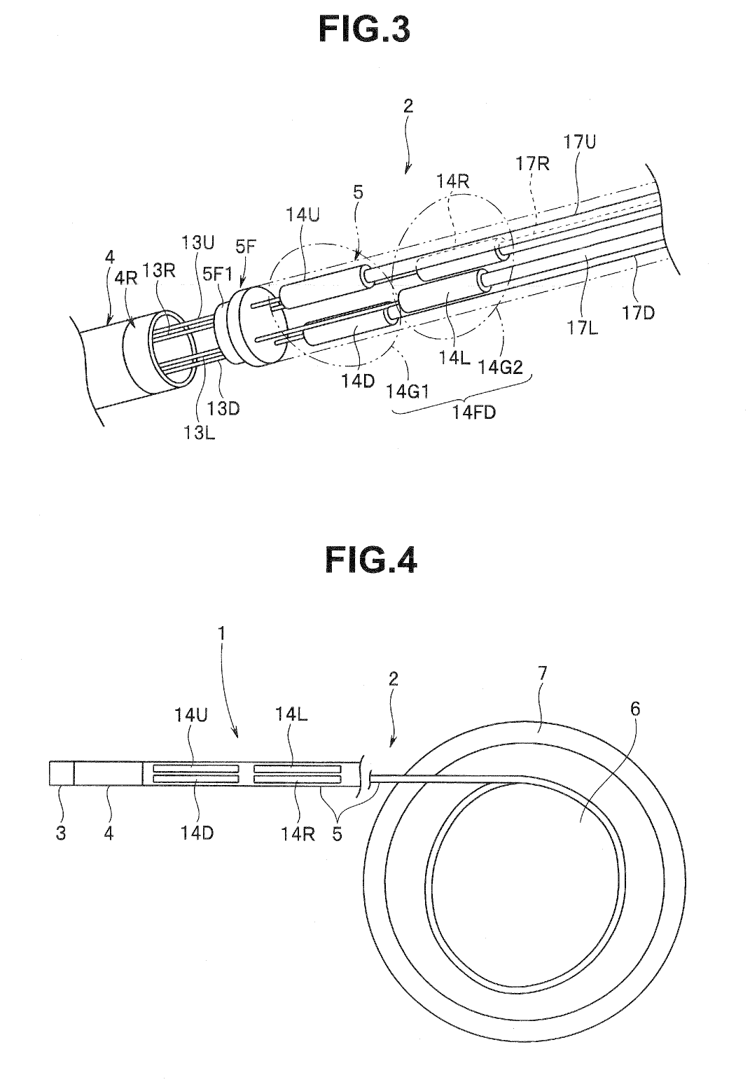

FIG. 3 is a view illustrating a flexible tube portion in which a first actuator group and a second actuator group are disposed apart from each other at a predetermined distance in a longitudinal direction, the first actuator group and the second actuator group each including two fluid actuators arranged in parallel and side by side adjacent to each other in the longitudinal direction.

FIG. 4 is a view illustrating the state where the two actuator groups disposed in the longitudinal direction in the flexible tube portion are pulled out from an outer circumferential surface of a drum.

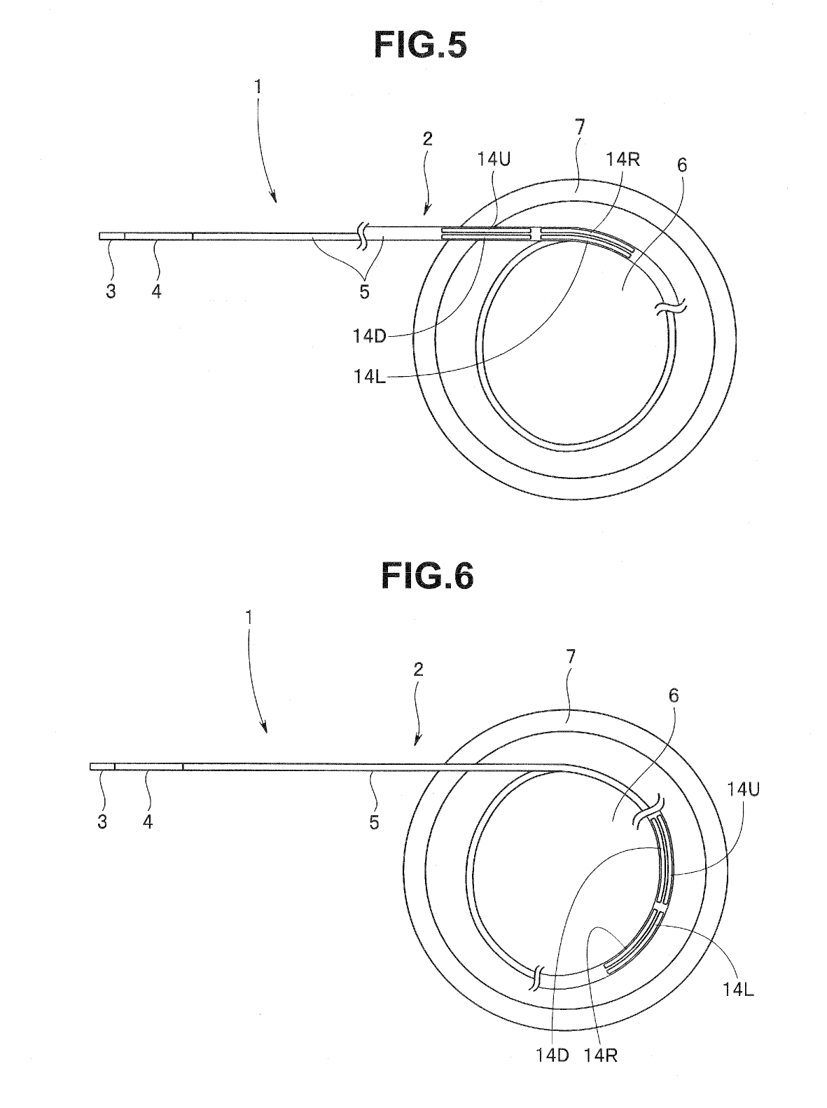

FIG. 5 is a view illustrating the state where the actuator group located on the distal end side of the flexible tube portion, which is one of the two actuator groups disposed in the longitudinal direction in the flexible tube portion, is pulled out from the outer circumferential surface of the drum, and the actuator group located on the proximal end side of the flexible tube portion, which is the other of the two actuator groups, is wound around the outer circumferential surface.

FIG. 6 is a view illustrating the state where the two actuator groups disposed in the longitudinal direction in the flexible tube portion are wound around the outer circumferential surface of the drum.

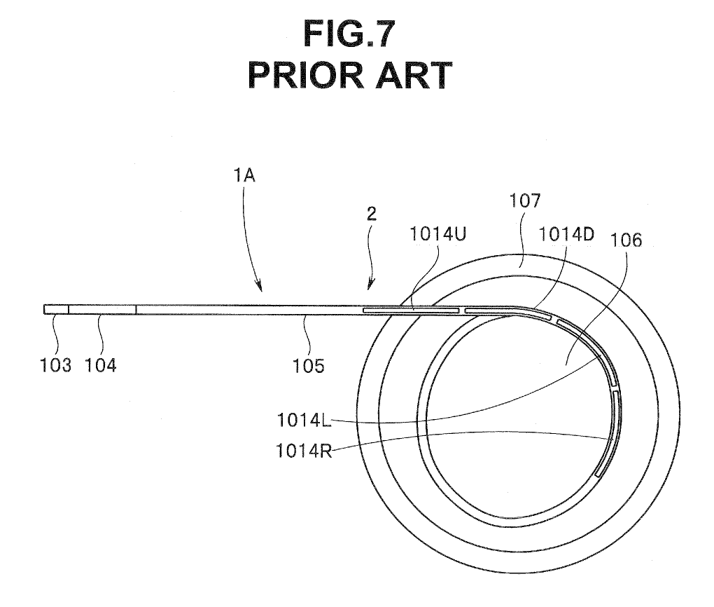

FIG. 7 is a view illustrating a conventional endoscope apparatus including a flexible tube portion in which four actuators are disposed in the longitudinal direction.

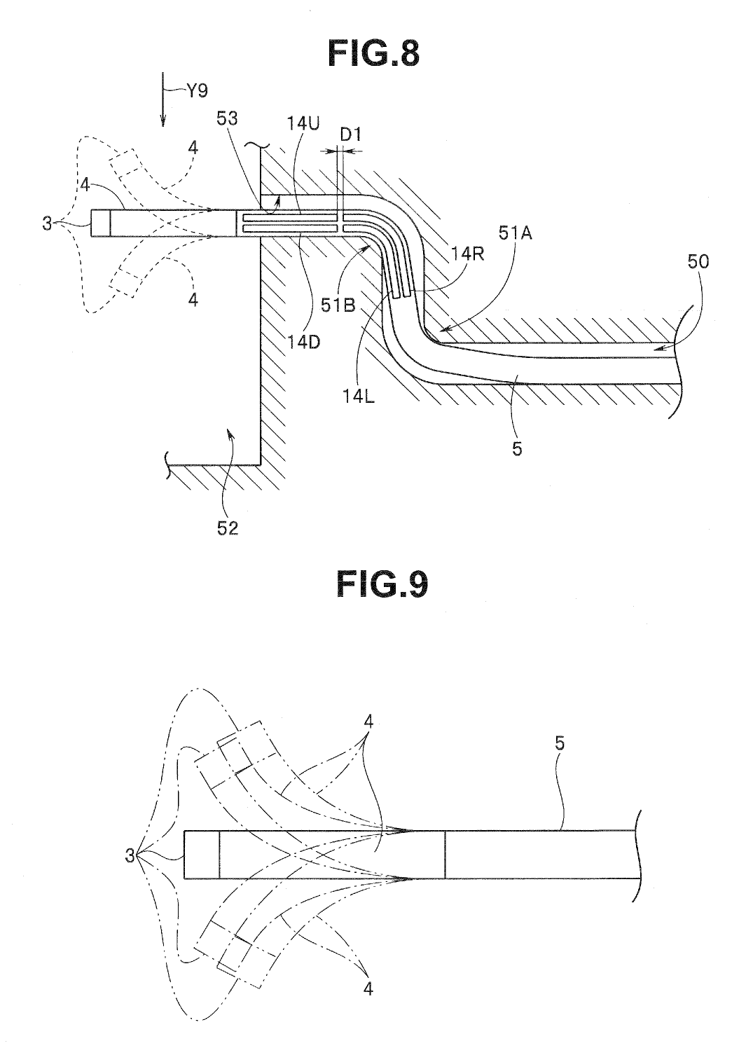

FIG. 8 is a view illustrating the state of the insertion section inserted through a pipe, where the actuator group located on the distal end side of the flexible tube portion, which is one of the two actuator groups disposed in the longitudinal direction in the flexible tube portion, is arranged in a pipe straight portion, and the actuator group located on the proximal end side of the flexible tube portion, which is the other of the two actuator groups, is arranged in an elbow portion.

FIG. 9 is a view illustrating the state where the bending portion is bent in the leftward/rightward direction when viewed from the direction of the arrow Y9 in FIG. 8.

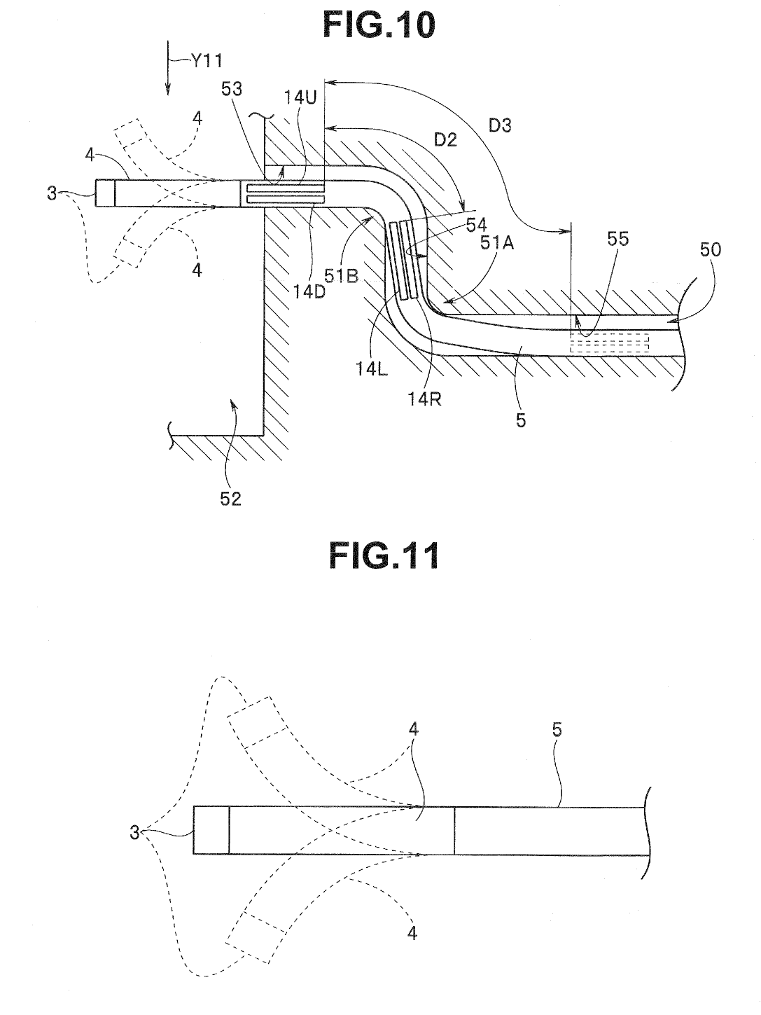

FIG. 10 is a view illustrating the state of the insertion section inserted through a pipe, where the actuator group located on the distal end side of the flexible tube portion, which is one of the two actuator groups disposed in the longitudinal direction in the flexible tube portion, is arranged in the pipe straight portion, and the actuator group located on the proximal end side of the flexible tube portion, which is the other of the two actuator groups, is arranged in an elbow straight portion or an insertion-port-side straight portion.

FIG. 11 is a view illustrating the state where the bending portion is bent in the leftward/rightward direction when viewed from the direction of the arrow Y11 in FIG. 10.

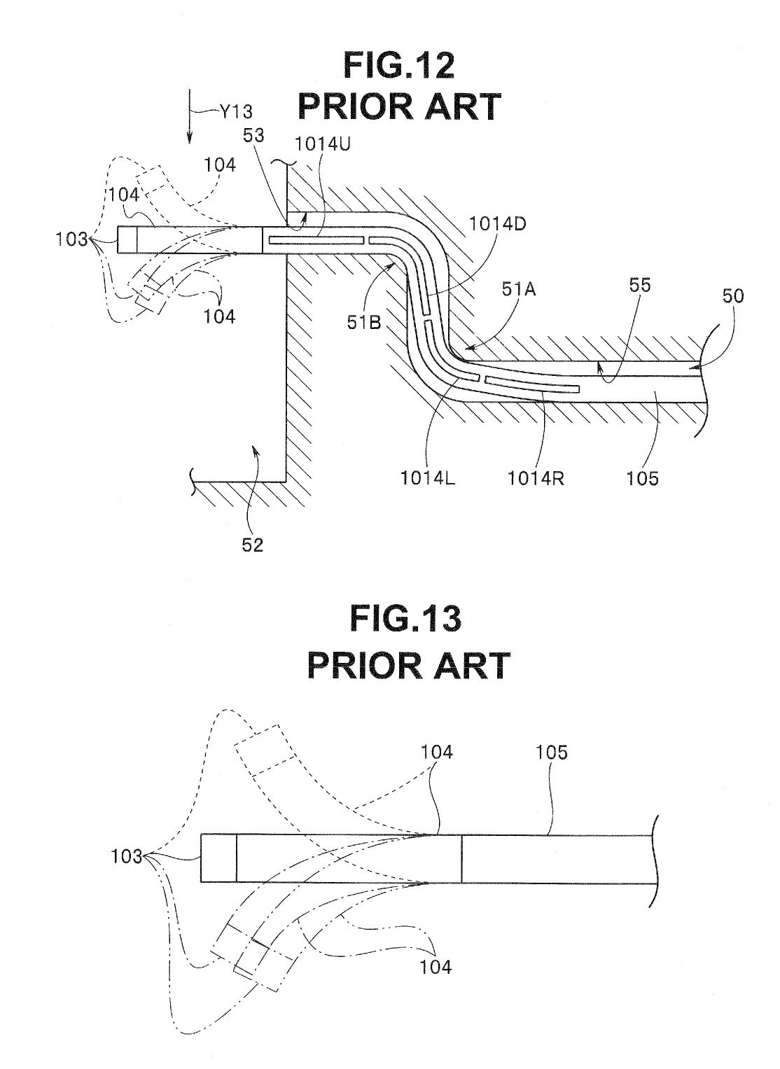

FIG. 12 is a view illustrating the state of the insertion section of the conventional endoscope apparatus inserted through the pipe, where the four actuators disposed in the longitudinal direction in the flexible tube portion are arranged in the pipe having an elbow portion.

FIG. 13 is a view illustrating the state where the bending portion of the conventional endoscope apparatus is bent in the leftward/rightward direction when viewed from the direction of the arrow Y13 in FIG. 12.

### DETAILED DESCRIPTION OF THE PREFERRED EMBODIMENT

Hereinafter, description will be made of an embodiment of the present invention with reference to the drawings.

As shown in FIG. 1, an endoscope apparatus 1 includes an elongated insertion section 2, a drum 6 around which the insertion section 2 is wound and housed, a box-shaped main body section 8, a monitor 9, and a protection frame 10.

The insertion section 2 includes in the following order from the distal end thereof: a distal end portion 3, a bending portion 4, and a flexible tube portion 5. A cover body 7 is provided integrally with the drum 6 at an outer circumferential portion of the drum 6. The cover body 7 is so arranged as to cover the drum 6, with a predetermined distance spaced from the outer circumference of the drum 6. The drum 6 and the cover body 7 are attached so as to rotate integrally with respect to the main body section 8. The monitor 9 is disposed on an upper portion of the main body section 8 and can be opened or closed with respect to the main body section 8, and may also be detachably connected to the main body section 8. The protection frame 10 is formed by linking a plurality of pipes, for example.

Note that the flexible tube portion 5 of the insertion section 2 is covered with an exterior mesh tube 5a. The exterior mesh tube 5a is a protection tube provided for the purpose of protecting the flexible tube portion 5 from getting crushed. The exterior mesh tube 5a includes a mesh tube portion, an impregnated portion, and a transition portion, for example.

As shown in FIG. 2, an image pickup device 11 and an illumination portion 12 are incorporated in the distal end portion 3 of the insertion section 2. The image pickup device 11 includes an objective optical system, and an image sensor such as a CCD or a CMOS. The illumination portion 12, for example, irradiates forward laser light transmitted by an optical fiber 19 as illumination light.

The bending portion 4 of the insertion section 2 includes a group of bending pieces which is configured by rotatably and consecutively connecting a plurality of bending pieces (not shown). The group of bending pieces is configured to be bent in the upward/downward direction and in the leftward/rightward direction. Four bending operation wires 13 are connected to the group of bending pieces. The four bending operation wires 13 include an upward direction bending operation wire (hereinafter, shortly referred to as up wire) 13U, a downward direction bending operation wire (hereinafter, shortly referred to as down wire) 13D, a leftward direction bending operation wire (hereinafter, shortly referred to as left wire) 13L, and a rightward direction bending operation wire (hereinafter, shortly referred to as right wire) 13R. First ends of the wires 13U, 13D, 13L and 13R are fixed respectively to the positions corresponding to up, down, left and right positions of the distal-most bending piece from among the group of bending pieces which comprise the bending portion 4, for example. The bending portion 4 is configured to be bent in the upward direction when the up wire 13U is pulled, for example.

The upward/downward direction agrees with the vertical transfer direction of the image sensor, and the leftward/rightward direction agrees with the horizontal transfer direction of the image sensor.

Second ends of the four wires 13U, 13D, 13L and 13R are connected to distal end sides of expansion/contraction bodies 15 which function as hydrodynamic muscles of four fluid actuators 14 which constitute a bending portion fluid driving portion 14FD. The four fluid actuators 14 include an upward direction actuator (hereinafter, shortly referred to as up actuator) 14U, a downward direction actuator (hereinafter, shortly referred to as down actuator) 14D, a leftward direction actuator (hereinafter, shortly referred to as left actuator) 14L, and a rightward direction actuator (hereinafter, shortly referred to as right actuator) 14R.

As shown in FIGS. 2 and 3, the up actuator 14U and the down actuator 14D comprise a first actuator group 14G1 for pulling the wire 13U and the wire 13D opposed to each other. The actuators 14U and 14D comprising the first actuator group 14G1 are arranged in parallel at the distal end side part of the flexible tube portion 5 such that the distal end surfaces of the actuators are located close to the proximal end of the bending portion 4.

On the other hand, the left actuator 14L and the right actuator 14R comprise a second actuator group 14G2 for pulling the wires 13L and 13R opposed to each other. The left actuator 14L and the right actuator 14R comprising the second actuator group 14G2 are disposed in parallel at positions nearer to the proximal end side of the flexible tube portion than the positions of the proximal end surfaces of the up actuator 14U and the down actuator 14D.

That is, the bending portion fluid driving portion 14FD is provided on the distal end side of the flexible tube portion 5 which is included in the insertion section 2. The bending portion fluid driving portion 14FD comprises the first actuator group 14G1 including the up and down actuators 14U and 14D disposed in parallel and side by side adjacent to each other, and the second actuator group 14G2 including the left and right actuators 14L and 14R disposed in parallel and side by side adjacent to each other, which groups are arranged in the longitudinal direction of the flexible tube portion 5. The first actuator group 14G1 and the second actuator group 14G2 are provided spaced apart from each other in the longitudinal direction of the flexible tube portion 5 by a predetermined distance in view of operational performance.

In FIG. 3, the reference numeral 4R denotes a bending portion proximal-end component and the reference numeral 5F denotes a flexible tube portion distal-end component. The flexible tube portion distal-end component 5F includes an engaging projection 5F1. The bending portion proximal-end component 4R and the flexible tube portion distal-end component 5F are integrally fixed to each other by adhesive bonding, soldering, or the like, with the engaging projection 5F1 being inserted in an inner hole of the bending portion proximal-end component 4R.

Since the actuators 14U, 14D, 14L and 14R are disposed in the flexible tube portion 5, as described above, the up wire 13U and the down wire 13D are set to the same length, and the left wire 13L and the right wire 13R are set to the same length. According to the configuration described above, the lengths of the left wire 13L and right wire 13R are longer than those of the up wire 13U and down wire 13D.

This arrangement of the bending portion fluid driving portion 14FD enables the first actuator group 14G1 to bend the bending portion 4 in a symmetrical manner in the upward/downward direction around a longitudinal axis of the flexible tube portion 5, and the second actuator group 14G2 to bend the bending portion 4 in a symmetrical manner in the leftward/rightward direction around the longitudinal axis of the flexible tube portion 5. See FIGS. 8-11. That is, when the first actuator group 14G1 is pulled out, single symmetrical movement can be achieved, and when the first and second actuator groups 14G1 and 14G2 are pulled out, double symmetrical movement can be achieved.

In the configuration described above, the first actuator group 14G1 includes the up actuator 14U and the down actuator 14D disposed in parallel, and the second actuator group 14G2 includes the left actuator 14L and the right actuator 14R disposed in parallel. However, the first actuator group 14G1 may include the left actuator 14L and the right actuator 14R disposed in parallel, and the second actuator group 14G2 may include the up actuator 14U and the down actuator 14D disposed in parallel.

Each of the actuators 14U, 14D, 14L and 14R includes a case body 16 and the expansion/contraction body 15 housed in the case body 16. The case body 16 has flexibility and is formed in a tubular shape with a resin member, for example. On the other hand, the expansion/contraction body 15 is made of a hollow silicone tube or the like having flexibility.

The expansion/contraction body 15 is expanded when air which is fluid is supplied thereto, and contracts when the air inside thereof is discharged. Note that air is supplied to the expansion/contraction body 15 in the present embodiment, but that other supply fluids may alternately be provided.

The proximal end of the expansion/contraction body 15 is connected with one end of a fluid tube 17 which serves as a fluid path. The fluid tube 17 includes an up fluid tube 17U connected to the up actuator 14U, an down fluid tube 17D connected to the down actuator 14D, a left fluid tube 17L connected to the left actuator 14L, and a right fluid tube 17R connected to the right actuator 14R.

As each of the expansion/contraction bodies 15 is expanded by the air supplied from the fluid tube 17, the wires 13U, 13D, 13L and 13R are pulled by the actuators 14U, 14D, 14L and 14R, respectively. When the air inside each of the expansion/contraction bodies 15 is discharged through the fluid tube 17, each of the expansion/contraction bodies 15 is contracted, thereby bringing the wires 13U, 13D, 13L and 13R into a relaxed state.

The drum 6 includes a camera control unit 21, an illumination control circuit 22, a bending control solenoid valve unit 23 and bending control circuit 24 which comprise a fluid control portion, and a slip ring 25.

The camera control unit 21 is electrically connected to the image pickup device 11 in the distal end portion 3 through a signal cable 18, and is also electrically connected to a control portion 32 provided in the main body section 8 through the slip ring 25.

The illumination control circuit 22 is connected to the optical fiber 19 that transmits laser light from, for example, a laser light source to the illumination portion 12. In addition, the illumination control circuit 22 is also electrically connected to the control portion 32 provided in the main body section 8 through the slip ring 25.

The bending control solenoid valve unit 23 includes four solenoid valves (not shown) which control supply and discharge of air to and from the actuators 14U, 14D, 14L and 14R. The bending control solenoid valve unit 23 and an air pressure adjuster 33 provided in the main body section 8 are connected to each other through an air tube 20 provided between the bending control solenoid valve unit 23 and the air pressure adjuster 33, with a rotary joint 40 disposed therebetween.

Specifically, the bending control solenoid valve unit 23 is provided with solenoid valves corresponding respectively to the upward, downward, leftward and rightward directions. The primary side of each of the solenoid valves is connected with the air tube 20. The secondary side of each of the solenoid valves is connected with the fluid tube 17. The fluid tube 17 includes the up fluid tube 17U, the down fluid tube 17D, the right fluid tube 17R, and the left fluid tube 17L, as described above.

The bending control solenoid valve unit 23 is electrically connected to the bending control circuit 24. The bending control circuit 24 is electrically connected to the control portion 32 in the main body section 8 through the slip ring 25.

The main body section 8 includes a power supply circuit 31, the control portion 32 as a main CPU, and the air pressure adjuster 33. The control portion 32 is electrically connected to the power supply circuit 31. The air pressure adjuster 33 includes an air filter.

In addition, the main body section 8 includes an external power supply plug 34, a battery holder 35H, an air connector 36, and a cartridge holder 37H.

The external power supply plug 34 is connected with an external power supply. Power is supplied from the external power supply to the power supply circuit 31 by connecting the external power supply to the plug 34. A battery 35 which is a secondary battery is detachably attached to the battery holder 35H. Power is supplied from the battery 35 to the power supply circuit 31 by attaching the battery 35 to the battery holder 35H.

The air connector 36 is connected with an air pipe which is equipped in a factory or the like. Air is supplied to the air pressure adjuster 33 through the air pipe by connecting the air pipe to the air connector 36. A gas cartridge 37 is detachably attached to the cartridge holder 37H. Air in the gas cartridge 37 is supplied to the air pressure adjuster 33 by attaching the gas cartridge 37 to the cartridge holder 37H.

Furthermore, the main body section 8 is provided with an operating remote controller 38 and the monitor 9 which are electrically connected to the control portion 32. It is noted that the monitor 9 can alternately function as both the display portion and the operating remote controller.

The operating remote controller 38 is an operation instruction portion for bending the bending portion 4 and also serves as a setting portion for performing various settings. An instruction signal outputted from the operating remote controller 38 is outputted to the control portion 32 by wire or radio.

In the endoscope apparatus 1, the drum 6 is rotatably attached with respect to the main body section 8 by the rotary joint 40. When the drum 6 is rotated, the insertion section 2 is wound around the outer circumferential surface of the drum 6 and housed thereon.

Description will now be made on the working of the endoscope apparatus 1 in which the first actuator group 14G1 and the second actuator group 14G2 are disposed, as described above, in the flexible tube portion 5 of the insertion section 2.

First, description will be made with respect to a case in which observation is performed by pulling out the insertion section 2 of the endoscope apparatus 1 such that the first actuator group 14G1 and the second actuator group 14G2 are extended outward from the outer circumferential surface of the drum 6. The insertion section 2 can be variably extended out from the drum by a first length whereby one actuator group is in contact with the outer circumferential surface of the drum 6 and the other actuator group is not in contact (FIG. 5), or a second length whereby both actuator groups are not in contact with the outer circumferential surface of the drum 6 (FIG. 4). In addition, the endoscope apparatus of the present embodiment is also operable when both actuator groups are in contact with the surface of the drum 6, as shown in FIG. 6.

According to the endoscope apparatus 1 of the present embodiment, the up actuator 14U and the down actuator 14D, and the left actuator 14L and the right actuator 14R, which are disposed in the flexible tube portion 5 of the insertion section 2, are extended outward from the outer circumferential surface of the drum 6 at the second length, as shown in FIG. 4, thereby causing the wires 13U, 13D, 13L and 13R to be pulled by the driving forces of the actuators 14U, 14D, 14L and 14R. As a result, the bending portion 4 is bent.

In other words, when an operator operates the operating remote controller 38 to output an instruction signal for bending the bending portion 4, the expansion/contraction body 15 of any of the actuators 14U, 14D, 14L and 14R corresponding to the instruction signal expands by an amount corresponding to the operation amount of the operating remote controller 38. Then, the wire 13U, 13D, 13L or 13R is pulled in accordance with the expansion of the expansion/contraction body 15, thereby causing the bending portion 4 to be bent in an operator's desired direction at a desired bending angle.

On the other hand, as shown in FIG. 5, when the insertion section 2 is extended by the first length, the up actuator 14U and the down actuator 14D, which comprise the first actuator group 14G1 which is located on the distal end side of the flexible tube portion 5 of the two actuator groups 14G1, 14G2 disposed in the flexible tube portion 5 of the insertion section 2, are extended outward from the drum 6, and the left actuator 14L and the right actuator 14R, which comprise the second actuator group 14G2, are arranged on the outer circumferential surface of the drum 6. In this arrangement, the expansion/contraction bodies 15 of the actuators 14U and 14D in the first actuator group 14G1 are capable of expanding similarly as described above. However, since the actuators 14L and 14R in the second actuator group 14G2 are arranged along the outer circumferential surface of the drum 6, the case bodies 16 of the actuators 14L and 14R are brought into a bent state. As a result, it is difficult for the expansion/contraction bodies 15 in the bent case bodies 16 to change into a predetermined expansion state, which results in a decrease in the pulling amount of the wires 13L and 13R by 5% to 30%, as compared with the case where the actuators 14L and 14R are extended outside of the drum 6.

That is, when the operator operates the operating remote controller 38 in the state where the up actuator 14U and the down actuator 14D are extended from the drum 6 and the left actuator 14L and the right actuator 14R are wound around the drum 6, the bending portion 4 is bent in the manner as described below. When the instruction signal for bending the bending portion 4 in the upward/downward direction is outputted from the operating remote controller 38, the bending portion 4 is bent in the operator's desired upward/downward direction at a preset bending angle. When the instruction signal for bending the bending portion 4 in the leftward/rightward direction is outputted, the bending portion 4 is bent in the operator's desired leftward/rightward direction, even though the case bodies 16 are bent. However, the bending angle of the bending portion 4 in this case is about 70% to 95% of the preset bending angle.

In addition, as shown in FIG. 6, when both of the first actuator group 14G1 and the second actuator group 14G2 which are disposed in the flexible tube portion 5 of the insertion section 2 are wound around the drum 6, the case bodies 16 of the actuators 14U, 14D, 14L and 14R are arranged on the outer circumferential surface of the drum 6 and brought into a bent state. Accordingly, it is difficult for the expansion/contraction bodies 15 in the bent case bodies 16 to change into a predetermined expansion state as described above, which results in a decrease in the pulling amount of the wires 13U, 13D, 13L and 13R by 5% to 30%. That is, when the operator operates the operating remote controller 38 to output the instruction signal for bending the bending portion 4, the bending portion 4 is bent in the operator's desired upward/downward direction and leftward/rightward direction at a bending angle which is about 70% to 95% of the preset bending angle.

As described above, in the endoscope apparatus according to the present embodiment, two actuator groups each having the two actuators disposed in parallel are provided in the flexible tube portion and the two actuator groups are disposed in the longitudinal direction of the flexible tube portion. With this configuration, even in the state where the actuators provided in the flexible tube portion of the insertion section are wound around the drum, it is possible to bend the bending portion by pulling the bending operation wires. Accordingly, such an endoscope apparatus can solve the problem of conventional endoscope apparatuses that it becomes difficult to pull out the bending operation wire, that is, the problem that the bending portion cannot be bent when in the wound state. Therefore, the endoscope apparatus of the present embodiment enables inspection and the like to be performed by bending the bending portion in the bending directions opposed to each other at the same bending angle.

According to the endoscope apparatus of the present embodiment in which the long insertion section is wound around the drum, inspection can be performed by pulling the insertion section out from the drum by a desired amount. Such a configuration can prevent the extra portion of the insertion section from being placed around the operator's feet. As a result, it is possible to surely prevent the insertion section from interfering with the inspection. In addition, according to the endoscope apparatus of the present embodiment, when inspection and the like of the pipe is performed by pulling the long insertion section wound around the drum entirely from the drum, for example, the inspection can be performed even while rewinding the insertion section onto the drum. Such a configuration can further improve the operability by eliminating a rewinding operation of the insertion section onto the drum again after the completion of inspection as required in the conventional endoscope apparatus.

Note that, in the conventional endoscope 1A disclosed in Japanese Examined Patent Application Publication No. 6-67378, when all the four actuators 1014U, 1014D, 1014L and 1014R disposed as shown in FIG. 7 are pulled out from the drum 106 having cover body 107, the bending portion 104 can be bent at the preset bending angle.

However, when only the up actuator 1014U located at the distal-most position among the four actuators 1014U, 1014D, 1014L and 1014R is extended from the drum 106, for example, other actuators, that is, the down actuator 1014D, the left actuator 1014L and the right actuator 1014R are wound around the drum 106.

In this state, when the operator operates the operating remote controller to output the instruction signal for bending the bending portion 104 in the upward direction, the bending portion 104 is bent in the operator's desired upward direction at the preset bending angle. However, when the instruction signal for bending the bending portion 104 in the downward, leftward, or rightward direction is outputted, the bending portion 104 is bent in the operator's desired downward, leftward or rightward direction at a bending angle which is about 70% to 95% of the preset bending angle. That is, it is difficult to bend the bending portion at the same bending angle even when the bending portion is bent in the directions opposed to each other.

Next, description will be made with respect to a case in which the inspection and the like is performed by passing the insertion section 2 of the endoscope apparatus 1 of the present embodiment through elbows 51A, 51B of a pipe 50, and introducing the insertion section 2 into a large space 52.

As shown in FIG. 8, in the state where the distal end portion 3 and the bending portion 4 of the insertion section 2 having the first actuator group 14G1 and the second actuator group 14G2 at the distal end side of the flexible tube portion 5 are introduced into the large space 52, there is a case where the first actuator group 14G1 is disposed in a pipe straight portion 53 and the second actuator group 14G2 is disposed in the second elbow 51B. In this case, the case bodies 16 of the actuators 14U and 14D in the first actuator group 14G1 are in a straight state, and on the other hand, the case bodies 16 of the actuators 14L and 14R are deformed to be in a bent state due to the bending of the flexible tube portion 5.

As a result, the amount of displacement of the wires 13U, 13D pulled by the actuators 14U, 14D disposed in the pipe straight portion 53 is different from the amount of displacement of the wires 13L, 13R pulled by the actuators 14L, 14R disposed in the second elbow 51B.

Therefore, when operating the operating remote controller 38 to output the instruction signal for bending the bending portion 4 in the upward/downward direction, the operator enables the bending portion 4 to be bent in the desired upward/downward direction at a preset bending angle for performing inspection, as shown in FIG. 8. On the other hand, when operating the operating remote controller 38 to output the instruction signal for bending the bending portion 4 in the leftward/rightward direction, the operator enables the bending portion 4 to be bent in the desired leftward/rightward direction at the bending angle shown by the one-dot chain lines which is about 70% to 95% of the preset bending angle shown by the two-dot chain lines, for performing inspection, as shown in FIG. 9.

According to the endoscope apparatus of the present embodiment, when the actuator groups provided in the flexible tube portion of the insertion section are arranged in the elbow of the pipe, the flexible tube portion is bent in the elbow, and the case bodies are deformed to be in a bent shape. However, even in the case where the case bodies are bent, the actuator enables the bending portion to be bent in a desired direction by pulling the bending operation wires. In addition, according to the endoscope apparatus of the present embodiment, when the bending portion is located in the large space, the operator can perform inspection by bending the bending portion in directions opposed to each other at the same bending angle.

Note that the following result can be obtained by setting, in advance, a position of the actuators 14L and 14R in the second actuator group 14G2 disposed in the flexible tube portion 5 at a first position shown by the solid lines or a second position shown by the dashed lines, as shown in FIG. 10.

The distance between the first actuator group 14G1 and the second actuator group 14G2 is set to the second distance D2, which is larger than the first distance D1 in FIG. 8, such that the second actuator group 14G2 disposed in the flexible tube portion 5 is arranged at the first position, that is, at the elbow straight portion 54 located between the first elbow 51A and the second elbow 51B.

According to such a configuration, as shown in FIG. 10, when operating the operating remote controller 38 to output the instruction signal for bending the bending portion 4 in the upward/downward direction, the operator enables the bending portion 4 to be bent in a desired upward/downward direction at the preset bending angle for performing inspection, in a similar manner as shown in FIG. 8. When operating the operating remote controller 38 to output the instruction signal for bending the bending portion 4 in the leftward/rightward direction, the operator also enables the bending portion 4 to be bent in a desired leftward/rightward direction at the preset bending angle for performing inspection, as shown in FIG. 11.

Note that the second position is an insertion-port-side straight portion 55 located at a position nearer to the pipe insertion port than the position of the first elbow 51A. The distance between the first actuator group 14G1 and the second actuator group 14G2 is set to a third distance D3 which is larger than the second distance D2, such that the second actuator group 14G2 disposed in the flexible tube portion 5 is arranged at the second position. As a result, when the operator operates the operating remote controller 38 to output the instruction signal for bending the bending portion 4, the bending portion 4 is bent in the desired upward/downward direction, and in the desired leftward/rightward direction at a preset bending angle, similarly as described above.

That is, with the endoscope apparatus of the present embodiment, the distance between the first actuator group 14G1 and the second actuator group 14G2 is set in advance to a distance required by the user, thereby providing a user-friendly endoscope apparatus.

As shown in FIG. 12, in the conventional endoscope 1A disclosed in the Japanese Examined Patent Application Publication No. 6-67378, when the distal end portion 103 and the bending portion 104 of the insertion section 102 are introduced into the large space 52, there is a case where the actuators provided in the flexible tube portion 105 are disposed such that the up actuator 1014U is at the pipe straight portion 53, the down actuator 1014D is at the second elbow 51B, the left actuator 1014L is at the first elbow 51A, and the right actuator 1014R is at the insertion-port-side straight portion 55.

In this case, the case bodies of the up actuator 1014U and the right actuator 1014R are in a straight state. However, the case bodies of the down actuator 1014D and the left actuator 1014L are deformed into a bent shape, since the flexible tube portion 105 is bent in the elbows 51B and 51A.

As a result, when the operator operates the operating remote controller to output the instruction signal for bending the bending portion 104 in the upward direction, the bending portion 104 is bent in the operator's desired upward direction at the preset bending angle as shown by the dashed lines in FIG. 12. On the other hand, when the instruction signal for bending the bending portion 104 in the downward direction is outputted, the bending portion 104 is bent in the operator's desired downward direction at the bending angle shown by the one-dot chain lines which is about 70% to 95% of the preset bending angle shown by the two-dot chain lines. That is, the bending angle of the bending portion in the upward direction is different from that in the downward direction.

In addition, when the instruction signal for bending the bending portion 104 in the rightward direction is outputted, the bending portion 104 is bent in the operator's desired rightward direction at the preset bending angle as shown by the dashed lines in FIG. 13. On the other hand, when the instruction signal for bending the bending portion 104 in the leftward direction is outputted, the bending portion 104 is bent in the operator's desired leftward direction at the bending angle shown by the one-dot chain lines which is about 70% to 95% of the preset bending angle shown by the two-dot chain lines. That is, the bending angle of the bending portion in the rightward direction is different from that in the leftward direction.

Accordingly, with the conventional endoscope apparatus, when the positions in the upper rightward direction and upper leftward direction of the pipe are inspected, the observation range in the upper leftward direction may be smaller than that in the upper rightward direction, which will affect the inspection performance.

The present invention is not limited to the precise embodiment set forth above, and it should be recognized that various changes and modifications thereof may be made by one skilled in the art without departing from the spirit or the scope of the invention.

What is claimed is:

1. An endoscope apparatus, comprising:
a drum; and
an elongated insertion section which is windable around the drum, the elongated insertion section comprising:
a flexible tube portion having first and second groups of actuators provided at a distal end thereof;
a bending portion provided at the distal end of the flexible tube portion, wherein the first and second groups of actuators are operable to bend the bending portion; and
a distal end portion which is provided at a distal end of the bending portion and which includes an image pickup device;
wherein the first and second groups of actuators each comprise two actuators which are arranged in parallel and side by side adjacent to each other in a longitudinal direction of the flexible tube portion; and
wherein the first and second groups of actuators are disposed apart from each other at a predetermined distance in the longitudinal direction of the flexible tube portion.

2. The endoscope apparatus according to claim 1, wherein the bending portion further comprises a plurality of bending operation wires each having a first end connected to the distal end of the bending portion, and a second end respectively connected to one of the plurality of actuators.

3. The endoscope apparatus according to claim 1, wherein each of the actuators comprises a case body and a hydrodynamic muscle as an expansion/contraction body.

4. The endoscope apparatus according to claim 2, wherein the bending operation wires connecting the first group of actuators to the distal end of the bending portion have a different length than the bending operation wires connecting the second group of actuators to the distal end of the bending portion.

5. The endoscope apparatus according to claim 2, wherein the bending portion comprises a plurality of connected bending pieces and is configured to be bent in an upward, downward, rightward, and leftward direction by operation of the bending operation wires.

6. The endoscope apparatus according to claim 3, wherein each actuator is connected to a respective fluid tube, and the expansion/contraction body thereof is expanded when a fluid is supplied thereto.

7. The endoscope apparatus according to claim 6, wherein the bending operation wires are operated by the expanding of the expansion/contraction body.

8. The endoscope apparatus according to claim 1, further comprising:
a main body section comprising a control portion, a power supply section, an air connector, and an air pressure adjuster; and
a protection frame provided around the drum and the main body section.

9. The endoscope apparatus according to claim 8, wherein the main body section further comprises:
a display rotatively connected to the main body section; and
an operating remote controller which accepts operation instructions for operation of the endoscope apparatus.

10. The endoscope apparatus according to claim 9, wherein the drum comprises:
a cover body provided at an outer circumferential portion of the drum;
a camera control unit which controls the image pickup device;
an illumination control circuit which controls an illumination portion provided in the distal end portion;
a bending control solenoid valve which controls supply of the fluid to the respective actuators; and
a bending control circuit which is electrically connected to the control portion and the bending control solenoid valve.

11. An endoscope apparatus, comprising:
an insertion tube including a flexible tube portion, a bending system, and an image pickup device, the bending system including a plurality of actuators which are provided in the flexible tube portion; and
a drum around which the insertion tube is wound;
wherein the plurality of actuators are positioned such that when the insertion tube is pulled out from the drum by a first length, a single symmetrical direction movement is enabled, and when the insertion tube is pulled out from the drum by a second length, a double symmetrical direction movement is enabled.

12. The endoscope apparatus according to claim 11, wherein the bending system further comprises a plurality of wires each having a first end connected to a bending portion of the insertion tube, and a second end respectively connected to one of the plurality of actuators.

13. The endoscope apparatus according to claim 12, wherein each actuator is connected to a respective fluid tube, and an expansion/contraction body thereof is expanded when a fluid is supplied thereto.

14. The endoscope apparatus according to claim 13, wherein the plurality of actuators comprise a first actuator group which bends the bending portion in an upward/downward direction, and a second actuator group which bends the bending portion in a leftward/rightward direction.

15. The endoscope apparatus according to claim 14, wherein the first actuator group and the second actuator group are disposed with a predetermined distance therebetween in a longitudinal direction of the insertion tube.

16. The endoscope apparatus according to claim 15, wherein the predetermined distance is set in advance in accordance with a shape of a pipe into which the insertion tube is to be inserted.
